(19) United States
(12) Patent Application Publication
(10) Pub. No.: US 2005/0173010 A1
(43) Pub. Date: Aug. 11, 2005

(54) Wall for a motor vehicle body

(75) Inventors: Norbert Schwan, Rutescheim (DE); Thiemo Adolf Erb, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: PORSCHE AG, Stuttgart (DE)

(21) Appl. No.: 10/979,806

(22) Filed: Nov. 3, 2004

(30) Foreign Application Priority Data
Mar. 11, 2003 (DE) DE 10351181.4-21

(51) Int. Cl. F16L 11/00

(52) U.S. Cl. 138/121

(57) ABSTRACT

A wall suitable for a motor vehicle body, in particular a passenger vehicle, is formed by a laminate body of multiple plastic layers. To optimize visible surface area, the wall has the layer structure in which a first outer layer is formed by a resin film, a second layer is formed by a nonwoven adjacent to the first layer, and a third layer is adjacent to the second layer and has at least one unidirectional layer.

### BACKGROUND OF THE INVENTION

This application claims the priority of DE 10351181.4-21, filed Nov. 3, 2003, the disclosure of which is expressly incorporated by reference herein.

The present invention relates to a wall for a body of a motor vehicle, in particular a passenger vehicle formed by a laminate comprising multiple layers of plastic.

A laminated component for a vehicle chassis having a fiber-free outer skin and a fiber-reinforced carrier structure is described in DE 102 02 911 C2, applied to an inside of this outer membrane to reinforce the outer membrane. A boundary layer is formed in the area of the interface and the carrier structure. Within the boundary layer, the fiber content is elevated with respect to the area of the carrier structure outside of the boundary layer. This approach is intended for temperature changes to have largely no influence on the quality of the surface.

DE 101 20 912 A1 describes a laminated component for a chassis, having a layer with an enamelable surface of short fiber-reinforced polyurethane and another layer of longer fiber-reinforced polyurethane. This layer structure should contribute toward optimizing the quality of the enameled surface.

### SUMMARY OF THE INVENTION

An object of this invention is to provide a wall for a body of a passenger vehicle through a targeted combination and configuration of plastic layers such that it will be characterized by a high quality level of the surface to be enameled.

This object has been achieved according to this invention by providing a wall having a resin film first outer layer, moreover a second layer adjacent to the outer layer, and a third layer having at least one unidirectional layer adjacent to the second layer.

Among the main advantages achieved with the present invention is that the composition of the layers of the wall incorporated into the passenger vehicle body, in particular the use of the moreover second layer, and the third layer comprised of at least one unidirectional layer, contributes toward preventing the superficial markings created by the woven fabric under the influence of temperature and moisture (movement of resin in relation to the matrix). A Class A surface can therefore be achieved on the outer layer of the wall, i.e., on its enamelable outside, which appears to be of a high quality on visual inspection.

In evaluating high quality, mainly long and short waviness, defects and/or the glossiness are taken into account. A combination of layers for a wall in which the second layer forms the outside is also achievable. The layers are commercially available and can be placed in a mold, e.g., an autoclave in the preimpregnated state—known as a prepreg. As a further embodiment, the nonwoven can be left dry, i.e., unimpregnated, so that it is impregnated by the adjacent layers and/or is bonded to the adjacent layers by gluing or joined by sewing or the like. It is also contemplated, however, to place the layers in a dry or unimpregnated state in the mold and then subject them to the resin injection process.

### BRIEF DESCRIPTION OF THE DRAWINGS

Other objects, advantages and novel features of the present invention will become apparent from the following detailed description of the invention when considered in conjunction with the accompanying drawings, in which:

FIG. 1 is a partial side schematic view of the body of a passenger vehicle in the area of a front side part with a wall according to the present invention,

FIG. 2 is a section along line II-II in FIG. 1,

FIG. 3 is a view of the section shown in FIG. 2, but rotated by 90°, and a mold shown schematically for producing the front end part, and

FIG. 4 is a sectional view along line IV-IV in FIG. 3 with a layer structure of the wall according to FIG. 1 as illustrated schematically.

### DETAILED DESCRIPTION OF THE DRAWINGS

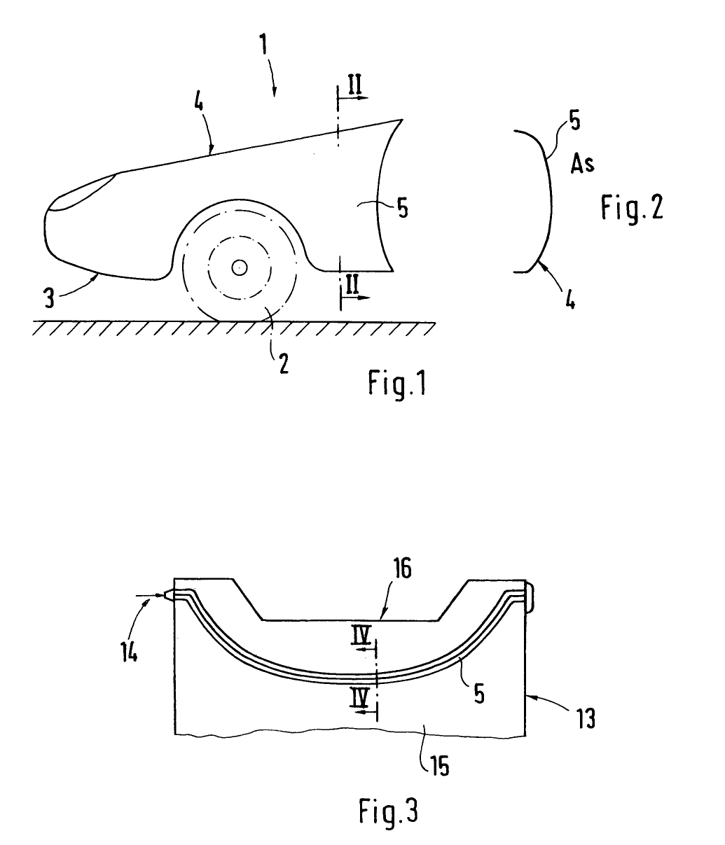

Only a front side part 4 of a passenger vehicle 1 comprising a body 3 supported by wheels 2 is shown in FIG. 1 in the form of a front left fender. The front side part 4 extends in the longitudinal direction of the passenger vehicle 1, e.g., from a windshield to a front-end part having a wall 5 made of a plastic of the laminated carbon-fiber-reinforced plastic type. The wall 5 has a surface of which is visible from the outside as of the passenger vehicle 1, and is enameled and provided with a high surface quality known as a class A surface.

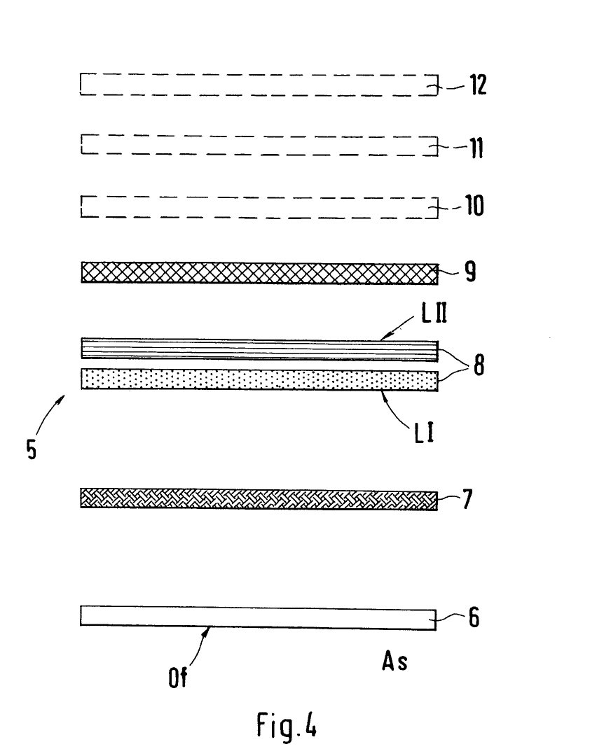

The wall 5 is therefore formed by a laminate comprising a multiple layer structure as seen in FIG. 4. A first outer layer 6 with the surface of is formed by a surface film with a resin layer having a low level of reinforcement, e.g., consisting of glass fibers GF, carbon fibers CF or other suitable reinforcing fibers. A second layer 7 represented by a nonwoven without a structural function is adjacent to the first layer 6. Suitable materials include glass fibers GF, carbon fibers CF, polyacrylonitrile, mesophase pitch and polyester PES. A third layer 8 with a structural function is applied to the second layer 7 and includes, for example, two layers with a unidirectional orientation—oriented 0° and 90°—consisting of carbon fibers CF or glass fibers GF. A fourth layer 9 which represents a structural base is bonded to the third layer 8 and may consist of a unidirectional woven fabric of carbon fibers CF or glass fibers GF. It is also contemplated that this layer can have a sandwich structure or a core laminate.

The layer 7 forming the nonwoven is joined to at least one of the adjacent layers, e.g., the first layer 6, bonded by adhesive or joined mechanically by sewing. It is also contemplated to form the nonwoven layer 7 as a prepreg which is held against one of the adjacent layers 6 or 8 because it is adhesive. In the illustrated embodiment, a fifth layer 10 may also be applied to the fourth layer 9 and optionally also a sixth layer 11 and a seventh layer 12 of woven fabric may also be applied.

In the method for producing the wall 5, the layers 8, 9, for example, are introduced in the form of prepregs into the manufacturing method and/or into a mold 13 shown schematically in FIG. 3. Other layers may optionally also be introduced in this state. At least one of the layers can, however, be introduced into the mold 13 in an unimpregnated state and jointly impregnated by the next adjacent impregnated layer.

Still another option is for the layers forming the wall 5 to be assembled in an unimpregnated state, i.e., to be placed dry in the mold 13 and then be impregnated with resin by an injection method. This resin is introduced at 14 into the mold 13, which is comprised of a bottom part 15 and a top part 16.

Finally, the surface of the wall 4 may be improved by applying a spray film (gel coat) to the outside As of the first layer 6.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Wall for a motor vehicle body passenger vehicle, comprising a laminate of plastic layers including,
a resin film first outer layer,
a nonwoven second layer adjacent to the outer layer, and
a third layer having at least one unidirectional layer adjacent to the second layer.

2. Wall as claimed in claim 1, further including a fourth layer of unidirectional woven fabric adjacent to the third layer.

3. Wall as claimed in claim 2, further including a fifth layer, with a sixth and seventh layers of woven fabric applied to the fourth layer.

4. Wall as claimed in claim 1, wherein the second nonwoven layer is joined to at least one of the layers adjacent thereto.

5. Wall as claimed in claim 1, wherein the second layer is joined mechanically to at least one adjacent layer.

6. Wall as claimed in claim 5, wherein the mechanical joining is a sewn joint.

7. Wall as claimed in claim 1, wherein the second layer is a prepreg.

8. Wall for a vehicle body, comprising a laminate of plastic layers, including a nonwoven outer layer and another layer being adjacent to the outer layer and having one or more unidirectional layers.

9. Method for manufacturing the wall as claimed in claim 1, comprising introducing at least the first layer and the second layer are introduced into a manufacturing operation as prepregs.

10. Method as claimed in claim 8, further comprising introducing other layers into the manufacturing operation as prepregs.

11. Method as claimed in claim 9, wherein at least one layer is impregnated by the next adjacent layer.

12. Method as claimed in claim 9, wherein certain layers are prepregs, and the outer layer is jointly impregnated by the certain prepreg layers.

13. Method as claimed in claim 9, wherein certain layers are assembled in an unimpregnated condition and are then are impregnated with resin by an injection method.

14. Method as claimed in claim 9, wherein a spray film is applied to an outside surface of the outer layer.
